(19) United States
(12) Patent Application Publication
(10) Pub. No.: US 2005/0239316 A1
(43) Pub. Date: Oct. 27, 2005

(54) Connector mounting structure, substrate, and electronic device

(75) Inventors: Hiroshi Yokozawa, Kawasaki (JP); Kaigo Tanaka, Kawasaki (JP); Sonomasa Kobayashi, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/170,437

(22) Filed: Jun. 30, 2005

Related U.S. Application Data
(63) Continuation of application No. PCT/JP03/05687, filed on May 7, 2003.

(51) Int. Cl. H01R 13/64

(52) U.S. Cl. 439/374

(57) ABSTRACT

A connector mounting structure for connecting a portable type recording connector 61 attached to a substrate, and a guide 62 positioned outside the substrate to hold portable type recording medium connected to the connector 61 in a predetermined position.

### BACKGROUND OF THE INVENTION

1. Technical Field

The present invention relates to a mounting structure for a portable type recording medium, such as a card connector, and to a substrate, and an electronic device.

2. Background Art

When connecting a card type recording medium, which is one kind of portable type recording mediums, to a PC (personal computer), a card connector is mounted on a substrate of the PC. A conventional card connector is mounted such that substantially the entire card connector is placed on the substrate.

Further, conventionally, there has been proposed a connector 11 equipped with an ejection mechanism 10 as shown in FIG. 10. In the connector 11 equipped with the ejection mechanism 10, movable ends 16a of a plurality of connection terminals 16 incorporated in a housing 12 are arranged on the inserting direction side for a card type recording medium 1.

Stationary ends 16b of the connection terminals 16 protrude on the ejecting direction side for the card type recording medium 1 outside the housing 12. Further, recording medium insertion guides 15 formed on the inner sides of an opening end of the housing 12 are arranged so as to be further offset toward the ejecting direction side than the stationary ends 16b of the connection terminals 16 (see, for example, Patent Document 1). In FIG. 10, reference numeral 2 indicates terminals.
[Patent Document 1]
   JP 2001-236472 A
[Patent Document 2]
   JP 10-255928 A

However, the conventional card connector, in which the major part of the card connector is placed on the substrate, has a problem in that the place allowing the mounting of the substrate is restricted. As a result, the degree of freedom in terms of component layout is rather low.

Further, the mounting of the card connector results in a reduction of the mounting area of the substrate, so that the mounting density is reduced.

In the connector 11 equipped with the ejection mechanism 10 shown in FIG. 10, the mounting space for the connector 11 can be diminished. In this connector 11, however, the entire connector 11 is placed on the substrate, so that the place allowing the mounting of the connector 11 is restricted, and the mounting density of the substrate is reduced.

### SUMMARY OF THE INVENTION

The present invention has been made in view of the above problems; it is an object of the present invention to provide a connector mounting structure, a substrate, and an electronic device which allow mitigation of the restriction in terms of the place for mounting a portable type recording medium and which can achieve an increase in substrate mounting density.

This makes it possible to achieve an increase in degree of freedom in terms of component layout. Further, this makes it possible to achieve a reduction in the size and cost of a substrate and an electronic apparatus.

To achieve the above object, the present invention adopts the following devices.

That is, the present invention relates to a connector mounting structure for connecting a portable type recording medium, including: a connector portion mounted to the substrate; and a guide portion situated outside the substrate, for retaining at a predetermined position the card type recording medium connected to the connector portion.

In the present invention, solely the connector portion of a connector is mounted to the substrate, and the guide portion of the connector is arranged outside the substrate, so that it is possible to mitigate the restriction in terms of connector mounting place and to achieve an increase in degree of freedom in terms of component layout.

Further, since the substrate mounting density can be increased, it is possible to achieve a reduction in the size and cost of a substrate and of an electronic device using the same.

Here, the guide portion can be fixed to the substrate through a fixing member.

Further, the portable type recording medium may be a card type recording medium.

The present invention relates to a substrate having a surface constituted by a predetermined region, including: a connector portion mounted to the surface; and a guide portion situated outside the region, for retaining at a predetermined position a portable type recording medium connected to the connector portion.

Here, the guide portion can be fixed to the substrate through the intermediation of a fixing member.

Further, the portable type recording medium may be a card type recording medium.

The present invention includes: a substrate; a connector portion mounted to the substrate; and a guide portion situated outside the substrate, for retaining at a predetermined position the portable type recording medium connected to the connector portion.

Here, the guide portion can be fixed to the substrate through a fixing member.

Further, the portable type recording medium may be a card type recording medium.

Further, the present invention may include a casing accommodating the substrate, the guide portion being fixed to the casing.

The present invention includes: a connector comprising: a connector portion mounted to a substrate; a guide portion situated outside the substrate, for retaining a portable type recording medium at a predetermined position when connecting the portable type recording medium to the connector portion: and a fixing member for fixing the guide portion to the substrate.

The above-mentioned components allow combination without departing from the gist of the present invention.

### BRIEF DESCRIPTION OF THE DRAWINGS

FIG. 1 is an exploded perspective view of an electronic device according to the present invention;

FIG. 2 is a perspective view of the outward appearance of the electronic device according to the present invention;

FIG. 3 is an exploded perspective view of a card connector;

FIG. 4 is a plan view of a card connector according to the present invention with a connector portion thereof mounted to a substrate;

FIG. 5 is a plan view of the connector portion according to the present invention;

FIG. 6 is a view taken in the direction of the arrow A of FIG. 5;

FIG. 7 is a perspective view showing how the card connector according to the present invention is mounted to the substrate;

FIG. 8 is a plan view of the card connector of the present invention with a card type recording medium inserted therein;

FIG. 9 is a plan view of another embodiment of the present invention; and

FIG. 10 is a plan view of a conventional example.

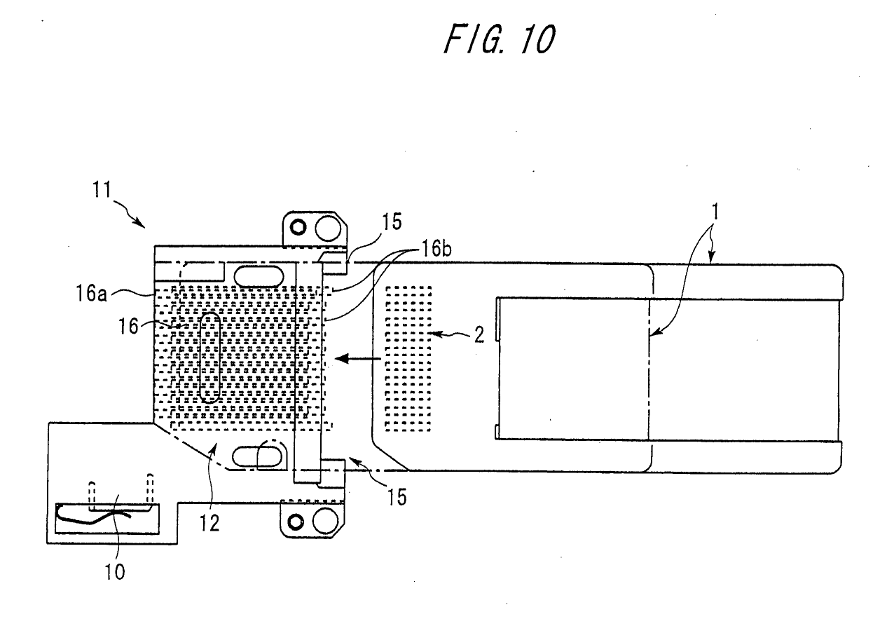

### DETAILED DESCRIPTION OF THE INVENTION

In the following, the embodiment of the present invention will be described with reference to the drawings.

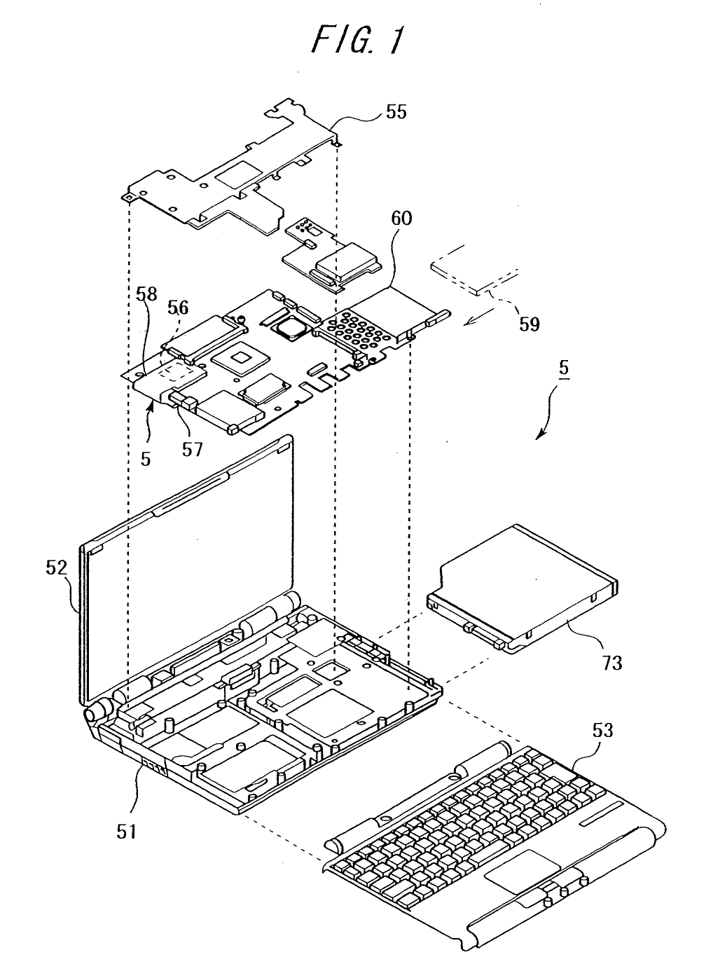

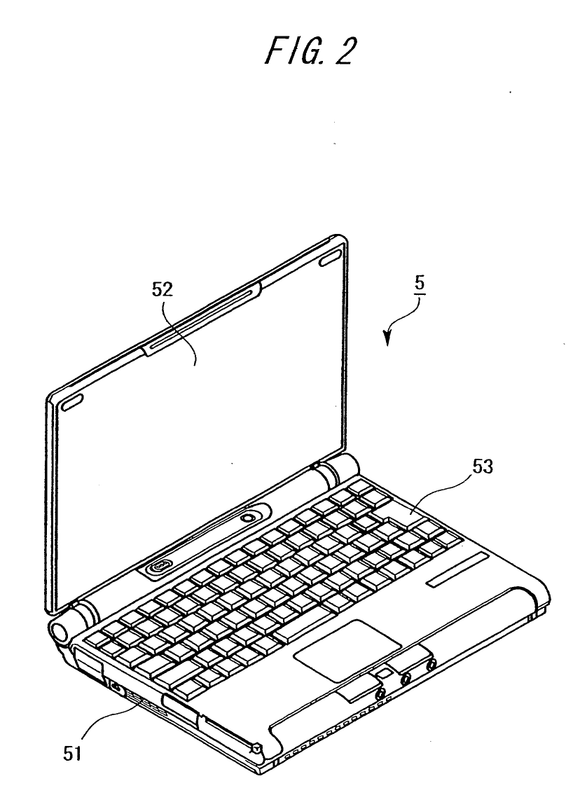

FIG. 1 is an exploded perspective view of a notebook PC 5 constituting an electronic device according to the present invention, and FIG. 2 is a perspective view of the outward appearance of the notebook PC 5.

The notebook PC 5 is equipped with a main body 51, an LCD (liquid crystal display) 52 provided on the main body 51 so as to be capable of being opened and closed, a keyboard 53 provided on the main body 51, a main board 54 which is a substrate accommodated in the main body 51, and a bay drive 73.

The main board 54 is equipped with a heat sink 55, a CPU 56, a fan 57 for cooling the CPU 56, a radiating plate 58 for conducting heat generated in the CPU 56 to the fan 57 side, and a card connector 60 for connecting a portable type recording medium, for example, a PC card 59, to the main board 54.

Next, the card connector 60 will be described. Apart from the card connector 60 and the mounting structure thereof, the above-mentioned components may be ones generally used, so a description thereof will be omitted.

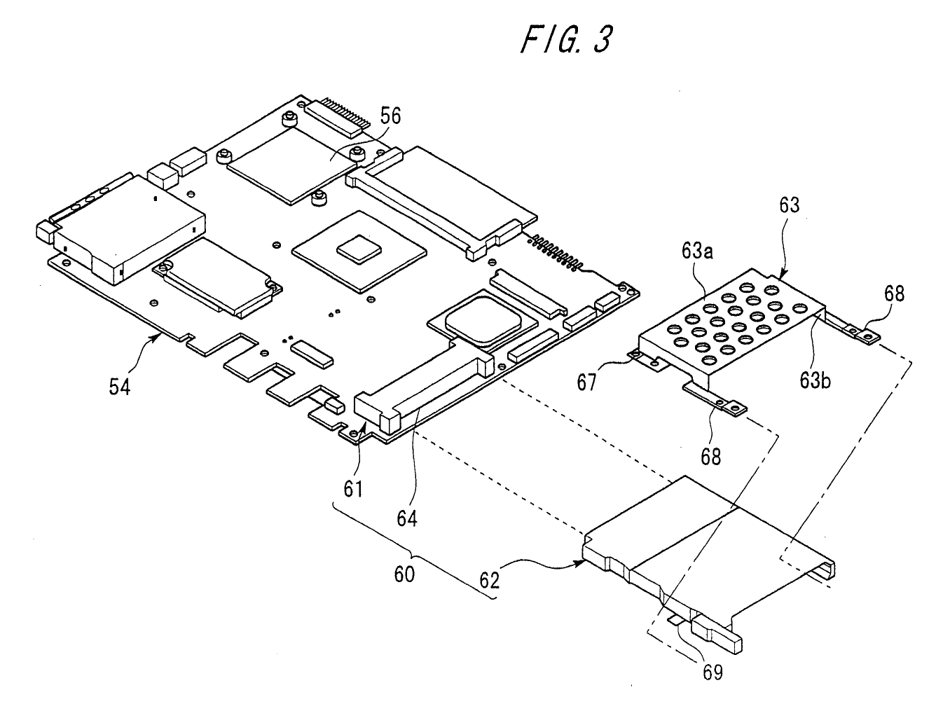

As shown in FIG. 3, the card connector 60 is equipped with a connector portion 61 mounted to the main board 54, a guide portion 62 situated on the outer side of the main board 54 in order to retain at a predetermined position the PC card 59 connected to the connector portion 61, and a fixing member 63 for fixing the guide portion 62 to the main board 54.

In the state shown in FIG. 3, the radiating plate 58 (see FIG. 1) provided on the CPU 56 has been removed.

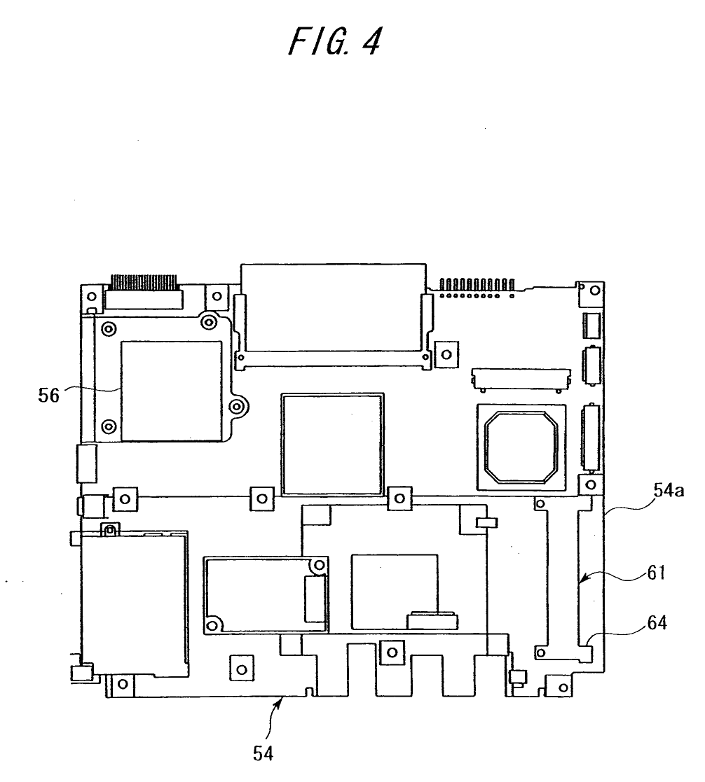

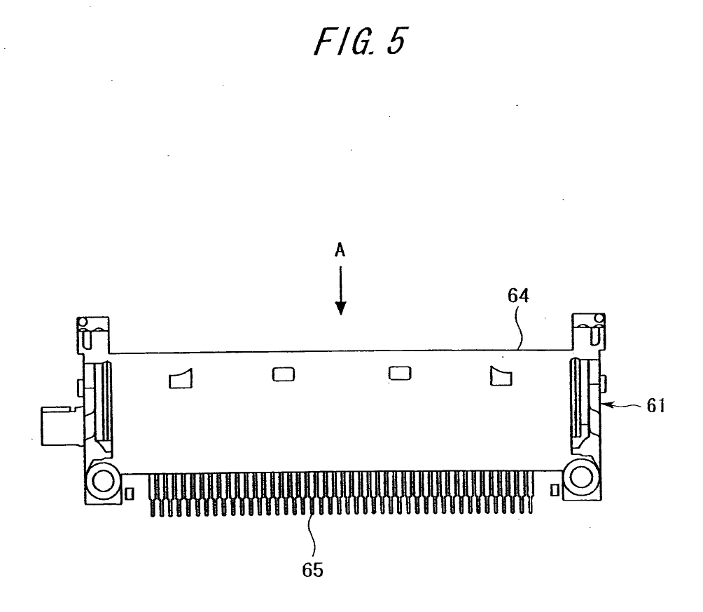

As shown in FIG. 4, the connector portion 61 is fixed at a position close to an end edge 54a of the main board 54. As shown in FIG. 5, the connector portion 61 is substantially rectangular, and has on one side thereof a recess 64 for inserting the PC card 59.

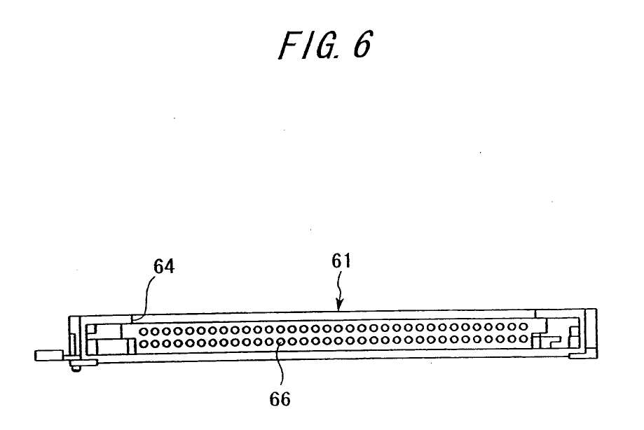

On the side opposite to the recess 64, there are provided a plurality of lead terminals 65 to be mounted on the main board 54. As shown in FIG. 6, a plurality of male terminals 66 are provided inside the recess 64. The terminals of the PC card 59 are connected to the male terminals 66.

The guide portion 62 shown in FIG. 3 has a flat, substantially U-shaped sectional configuration. The guide portion 62 is arranged outside the main board 54 with its open side facing downwards.

Further, the fixing member 63 has a substantially U-shaped sectional configuration. One end portion 63a of the fixing member 63 covers an end portion of the connector portion 61, and the fixing member 63 is fixed to the main board 54, with the major portion thereof protruding from the main board 54.

The lower ends of corner portions of the fixing member 63 are provided with mounting portions 67 for fixation to the main board 54, and mounting portions 68 for mounting the guide portion 62.

On one end portion side of the guide portion 62, there are provided mounting portions 69 for mounting to the fixing member 63.

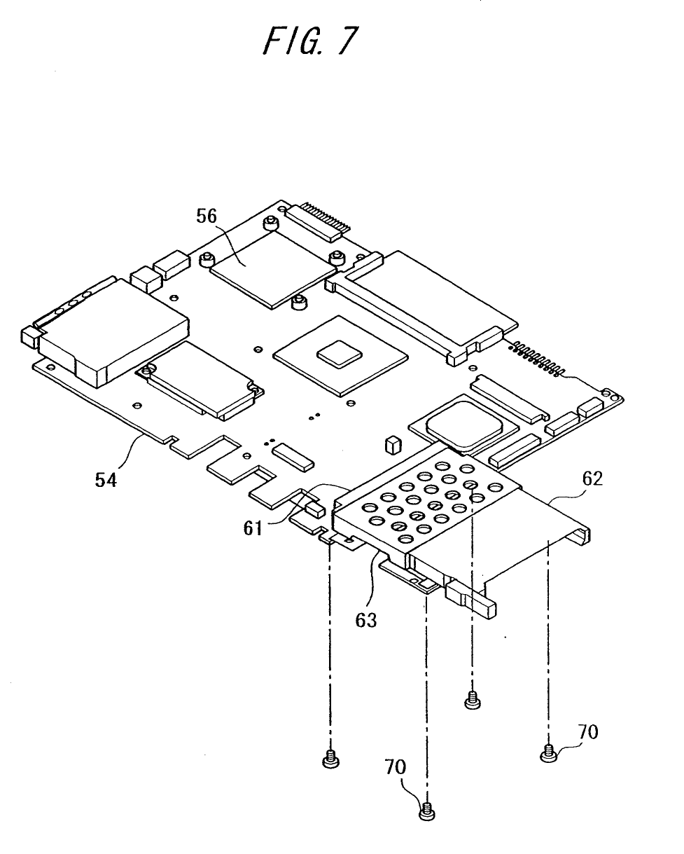

When mounting the guide portion 62 to the main board 54, the guide portion 62 is inserted into the recess 63b of the fixing member 63, and one mounting portions 68 of the fixing member 63 and the mounting portions 69 of the guide portion 62 are fastened together by screws 70 (see FIG. 7).

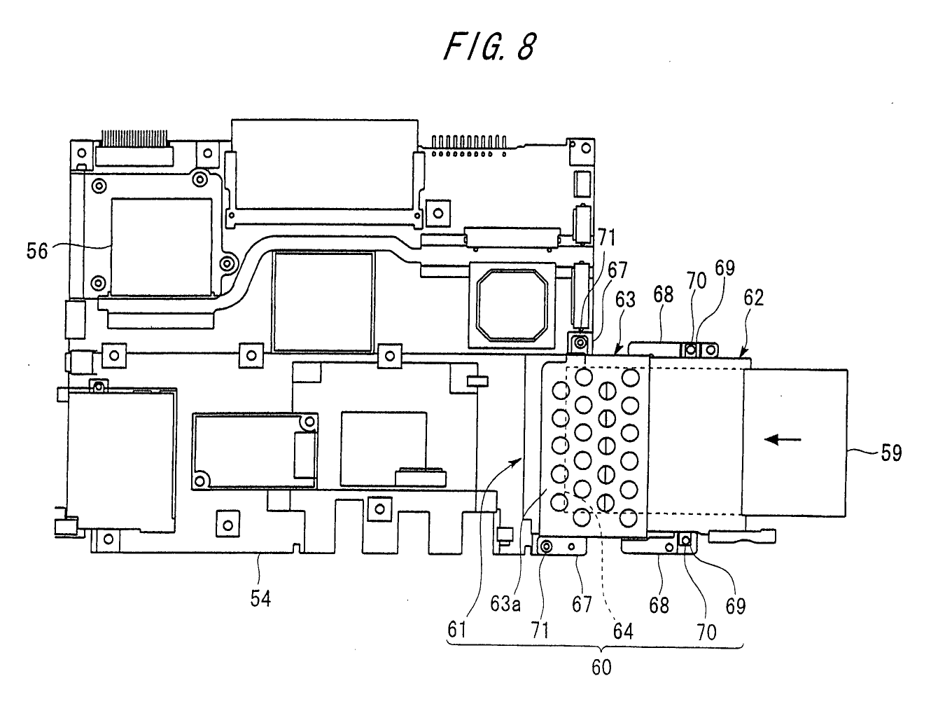

Next, as shown in FIG. 8, with the end portion 63a of the fixing member 63 overlapping the connector portion 61, the other mounting portions 67 of the fixing member 63 are mounted to the main board 54 by screws 71.

As a result, the connector portion 61 and the guide portion 62 are secured in a predetermined positional relationship. And, as shown in FIG. 8, when the PC card 59 is inserted into the guide portion 62, the PC card 59 is inserted into the recess 64 of the connector portion 61 without undergoing any positional deviation. As a result, the PC card 59 is connected to the connector portion 61.

In this way, in the present invention, only the connector portion 61 of the card connector 60 is mounted to the main board 54, and the guide portion 62 is arranged on the outer side of the main board 54, so that it is possible to diminish the requisite space in the main board 54 for the mounting of the card connector 60.

Thus, when mounting the card connector 60 to the main board 54, there is little restriction in terms of the mounting place, so that it is possible to achieve an increase in degree of freedom in terms of component layout.

Further, it is possible to increase the mounting density of the main board 54. This makes it possible to achieve a reduction in the size and cost of the main board 54. Further, it is possible to achieve a reduction in the size and cost of an electronic device using the main board 54, for example, the notebook PC 5.

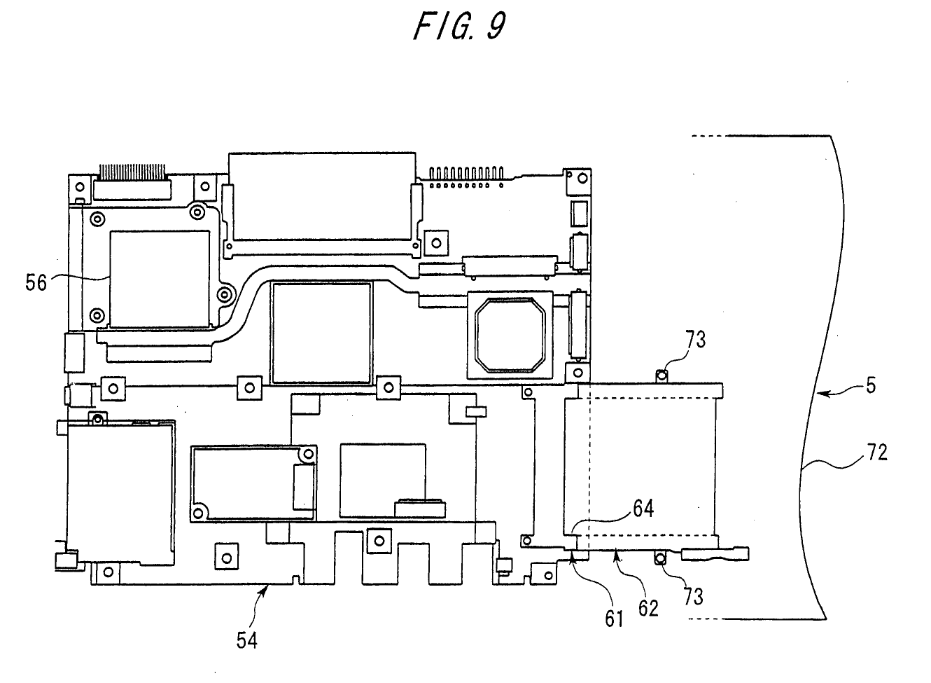

While in the above embodiment the guide portion 62 of the card connector 60 is fixed to the main board 54 through the fixing member 63, it is also possible, as shown in FIG. 9, to fix the guide portion 62 to a casing 72 of the notebook PC 5.

In this case, the mounting portions 69, 69 of the guide portion 62 are fixed to the casing 72 by screws 73. In this case also, only the connector portion 61 is mounted to the main board 54, and the guide portion 62 is situated on the outer side of the main board 54, so that the same effect as mentioned above can be exerted.

While in the above-described embodiment the PC card 59, which is a card type recording medium, is used, the present invention is also applicable to various portable type recording mediums, such as a CF (Compact Flash) card, an MS (Memory Stick) card, an SD card, aa smart media card, and an xD picture card.

Industrial Applicability

The present invention is applicable to various electronic devices, such as computers.

1. A connector mounting structure connecting a portable type recording medium to a substrate, comprising:
a connector portion mounted to the substrate; and
a guide portion situated outside the substrate, retaining at a predetermined position the card type recording medium connected to the connector portion.

2. A connector mounting structure according to claim 1, wherein the guide portion is fixed to the substrate through a fixing member.

3. A connector mounting structure according to claim 1, wherein the portable type recording medium is a card type recording medium.

4. A substrate having a surface constituted by a predetermined region, comprising:
a connector portion mounted to the surface; and
a guide portion situated outside the region, retaining at a predetermined position a portable type recording medium connected to the connector portion.

5. A substrate according to claim 4, wherein the guide portion is fixed to the substrate through a fixing member.

6. A substrate according to claim 4, wherein the portable type recording medium is a card type recording medium.

7. An electronic device comprising:
a substrate;
a connector portion mounted to the substrate; and
a guide portion situated outside the substrate, retaining at a predetermined position the portable type recording medium connected to the connector portion.

8. An electronic device according to claim 7, wherein the guide portion is fixed to the substrate through a fixing member.

9. An electronic device according to claim 7, wherein the portable type recording medium is a card type recording medium.

10. An electronic device according to claim 7, comprising a casing accommodating the substrate,
wherein the guide portion is fixed to the casing.

11. A connector comprising:
a connector portion mounted to a substrate;
a guide portion situated outside the substrate, retaining a portable type recording medium at a predetermined position when connecting the portable type recording medium to the connector portion; and
a fixing member for fixing the guide portion to the substrate.
